(19) United States
(12) Patent Application Publication
(10) Pub. No.: US 2015/0232032 A1
(43) Pub. Date: Aug. 20, 2015

(54) REAR-VIEW MIRROR

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: WEI-FENG WU, Shenzhen (CN)

(21) Appl. No.: 14/497,064

(22) Filed: Sep. 25, 2014

(30) Foreign Application Priority Data
Feb. 14, 2014 (CN) 2014100512118

(51) Int. Cl. B60R 1/04; G02B 17/08

(52) U.S. Cl. CPC B60R 1/04; G02B 17/0856

(57) ABSTRACT

A rear-view mirror is for the driver to view the rear of the vehicle. The rear-view mirror includes a concave lens positioned in the vehicle body and a reflective module installed in the vehicle. The concave lens is positioned outwardly from the vehicle body. The reflective module includes a reflective mirror optically coupled with the concave lens. The concave lens is applied to the vehicle replacing the traditional rear-view mirror, therefore the width of the vehicle body is reduced, and very convenient for the driver to view the rear of the vehicle.

### FIELD

The subject matter herein generally relates to rear-view mirrors.

### BACKGROUND

It is very important that a rear-view mirror for vehicle has a clear and accurate view and is comfortable, and safe to use. In order to expand a driver's view while driving, the size of the rear-view mirror has increased.

### BRIEF DESCRIPTION OF THE DRAWINGS

Implementations of the present technology will now be described, by way of example only, with reference to the attached figures.

FIG. 1 is an abbreviated structural perspective view of an embodiment of a rear-view mirror.

FIG. 2 is a structural perspective view of a concave lens of the rear-view mirror of FIG. 1.

FIG. 3 is an isometric view of a reflective module of the rear-view mirror of FIG. 1.

FIG. 4 is a diagrammatic light path of the rear-view mirror of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “outside” refers to a region that is beyond the outermost confines of a physical object. The term “comprising,” when utilized, means “including, but not necessarily limited to”; it specifically indicates open-ended inclusion or membership in the so-described combination, group, series and the like.

The present disclosure is described and in relation to a rear-view mirror.

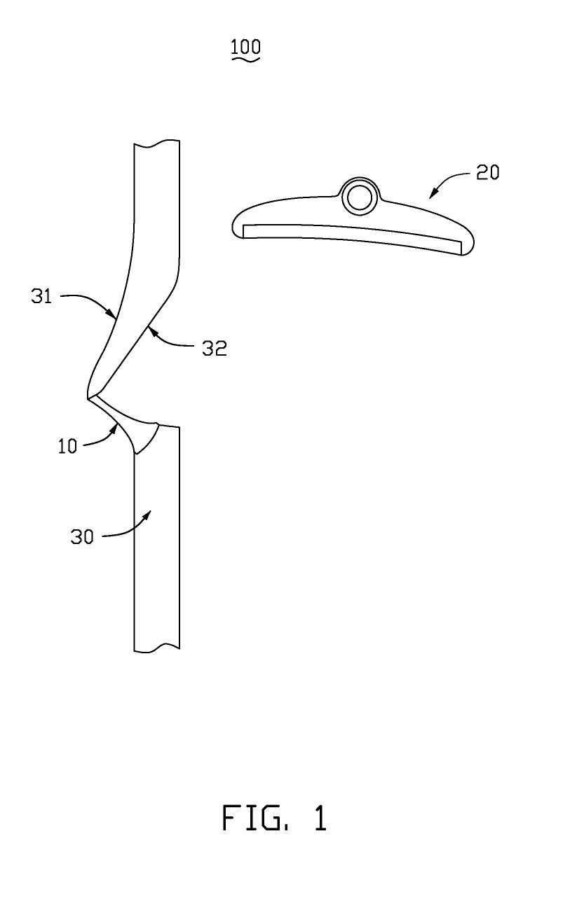

FIG. 1 illustrates a first embodiment of a rear-view mirror 100 can be applied to vehicles, such as a car. The vehicle can include a vehicle body 30 (only part of the vehicle body is shown). The rear-view mirror 100 can include a concave lens 10 positioned on the vehicle body 30 and a reflective module 20 installed in the vehicle. The vehicle body 30 can include a connecting portion 31 connected to the concave lens 10. The connecting portion 31 can be defined by outwardly extending from a part of the vehicle body 30. The thickness of the connection portion 31 can decrease as the distance to the vehicle body 30 increases. The connection portion 31 can include an inner sidewall 32. The inner sidewall 32 can be planar or curved.

The concave lens 10 can outwardly protrude from the vehicle body 30 adjacent to the position of a driver or a passenger. That is, an end of the concave lens 10 can be positioned in or be attached to the vehicle body 30, and the other end of the concave lens 10 can outwardly extend away from the vehicle body 30 and be connected to the inner sidewall 32. An included angle of the concave lens 10 and the inner sidewall 32 can be a right angle or an obtuse angle to avoid blocking the light from being transmitted into the vehicle through the concave lens 10.

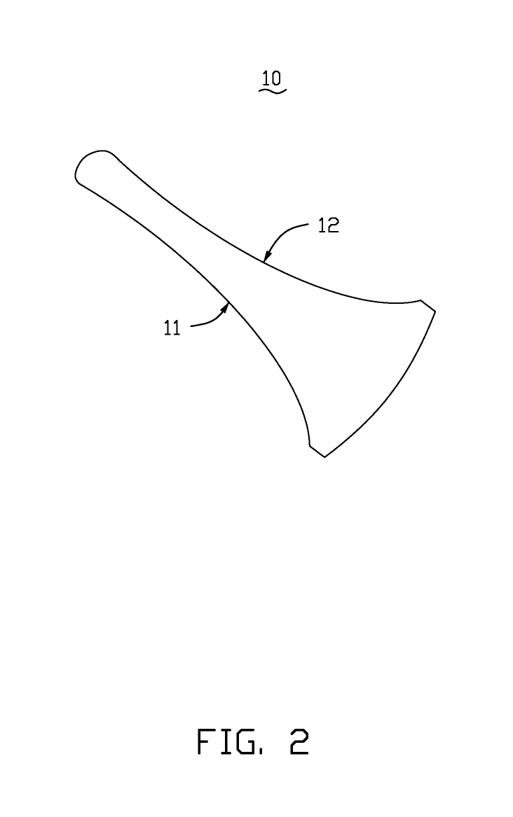

FIG. 2 illustrates that the concave lens 10 can be a biconcave lens. The concave lens 10 can include a light incident surface 11 and a light emitting surface 12 opposite to the light incident surface 11. The light incident surface 11 can face outside the vehicle, and the light emitting surface 12 can face inside the vehicle. The light incident surface 11 and the light emitting surface 12 can be axisymmetrical. Both the light incident surface 11 and the light surface 12 can be concave cylindrical surface. At least one of the light incident surface 11 or the light surface 12 can be coated by a transparent reflective film (not shown) to prevent the light from shining in the drivers eyes.

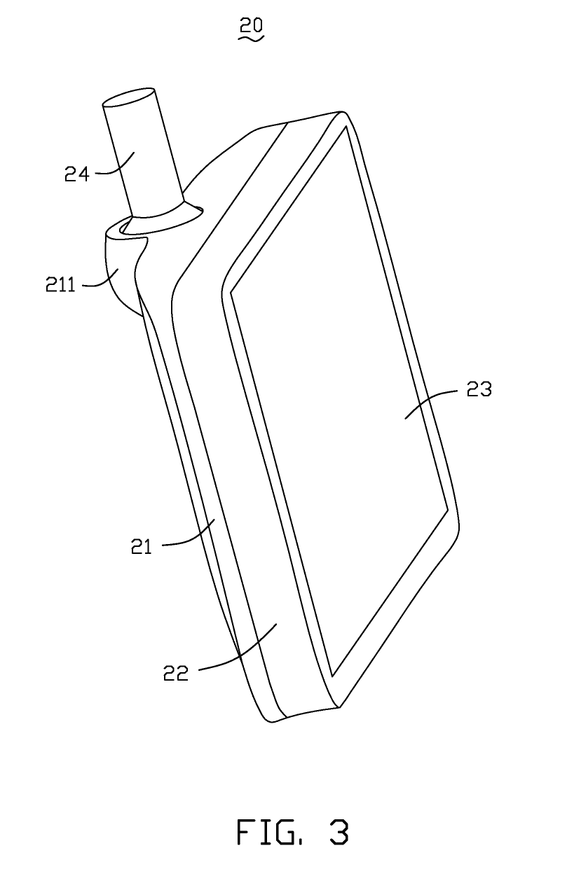

FIG. 3 illustrates that the reflective module 20 can include a housing 21, a frame 22 mounted on the housing 21, a reflective mirror 23 positioned in the frame 22, and a fixing pole 24 connected to the housing 21. The housing 21 can include a pivotal portion 211, and the pivotal portion 211 can be hollow sphere. One end of the fixing pole 24 can be rotatably connected to the pivotal portion 211. The reflective mirror 23 can be a concave mirror, and can be coated by an anti-glare film (not shown) to prevent the light from shining in the driver's eyes. The reflective module 20 can be attached to the inside of the vehicle by the fixing pole 24. The reflective module 20 can be adjacent to the concave lens 10 (shown in FIG. 1). The reflective mirror 23 can be optically coupled to the concave lens 10 (shown in FIG. 1). The included angle of the reflective mirror 23 relative to the concave lens 10 (shown in FIG. 1) can be freely adjusted via the rotation of the housing 21.

In assembly, the concave lens 10 can be positioned on the vehicle body 30. Then the reflective module 20 can be installed in the vehicle, and be adjacent to the concave lens 10. In addition, the reflective mirror 23 can be optically coupled to the concave lens 10.

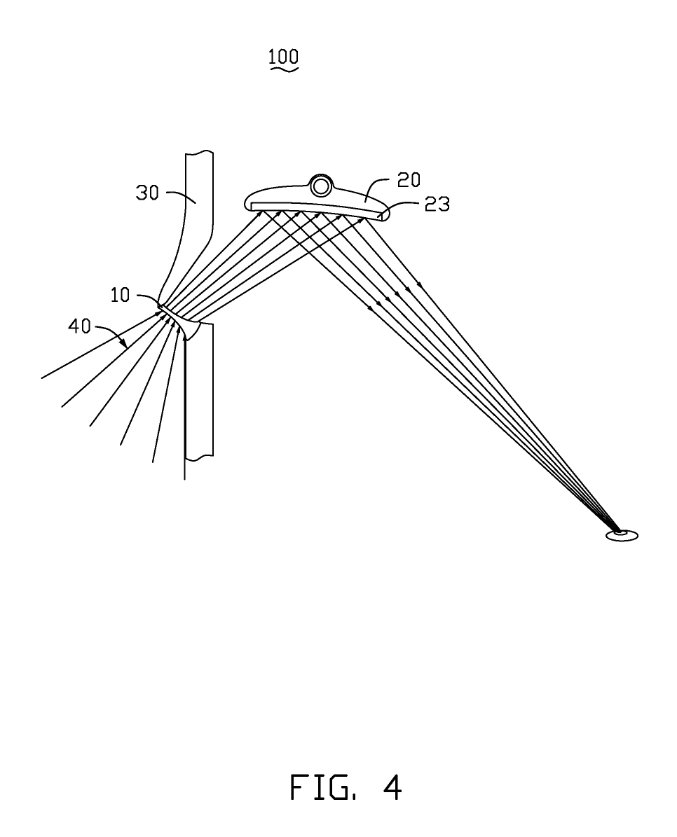

FIG. 4 illustrates a schematic light path of the rear-view mirror 100. The visible incident light 40 can be transmitted to the corresponding reflective mirror 23 by passing through the concave lens 10, and can be viewed by the driver via the reflective mirror 23. Therefore, the driver can view the scene at the rear of the vehicle. The included angle of the reflective mirror 23 relative to the concave lens 10 can be freely adjusted, and the incident angle of the reflected light transmitted to the eyes of the driver can be freely adjusted. Therefore, it is convenient for the driver to adjust the rear-view mirror 100 while driving. In addition, the reflective mirror 23 can be installed in shaded interior of the vehicle, the scene in the reflective mirror 23 can be clearly viewed by the driver.

In the other embodiments, a concave lens can be positioned on the windshield of a car door adjacent to the driver or the passenger. The concave lens can be a part of the windshield.

A reflective module can include only a reflective mirror, and can be a part of a windshield at the front of the vehicle. In addition, the reflective mirror does not influence what the driver observes on the road ahead.

As described above, the incident light 40 of the view from the rear of the vehicle can be transmitted to the reflective module 20 installed in the vehicle by the refraction of the concave lens 10 positioned in the vehicle body 30, and the reflected light can be transmitted for the driver to view. The concave lens 10 is applied to the vehicle replacing the traditional rear-view mirror; therefore the image of the width of the vehicle body 30 is reduced. The reflective module 20 is installed in the vehicle, and it is convenient to view the rear of the vehicle and adjust the included angle of the reflective mirror 23. In addition, the reflective mirror 23 can be installed in shaded interior of the vehicle, the scene in the reflective mirror 23 can be clearly viewed by the driver.

The embodiments shown and described above are only examples. Many details are often found in the art such as the other features of a rear-view mirror. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A rear-view mirror configured for a vehicle which has a vehicle body comprising:
a concave lens positioned in the vehicle body; and
a reflective module stalled in the vehicle and comprising a reflective mirror optically coupled to the concave lens;
wherein the concave lens is configured to transmit light out of the vehicle to the corresponding reflective mirror by passing through the concave lens.

2. The rear-view mirror as claimed in claim 1, wherein the concave lens is a biconcave lens.

3. The rear-view mirror as claimed in claim 1, wherein the concave lens includes a light incident surface and a light emitting surface opposite to the light incident surface.

4. The rear-view mirror as claimed in claim 3, wherein at least one of the light incident surface or the light surface is coated by a transparent reflective film.

5. The rear-view mirror as claimed in claim 3, wherein both the light incident surface and the light surface are concave cylindrical surface.

6. The rear-view mirror as claimed in claim 1, wherein the reflective mirror is a concave mirror.

7. The rear-view mirror as claimed in claim 1, wherein the reflective mirror is coated by an anti-glare film.

8. The rear-view mirror as claimed in claim 1, wherein the vehicle body includes a connecting portion connected to the concave lens.

9. The rear-view mirror as claimed in claim 8, wherein the thickness of the connection portion decreases as the distance to the vehicle body increases.

10. The rear-view mirror as claimed in claim 8, wherein the included angle of the concave lens and the connecting portion is a right angle.

11. The rear-view mirror as claimed in claim 8, wherein the included angle of the concave lens and the connecting portion is an obtuse angle.

12. The rear-view mirror as claimed in claim 1, wherein the reflective module further includes a housing and a fixing pole connected to the housing.

13. The rear-view mirror as claimed in claim 12, wherein the reflective mirror is installed in the housing.

14. The rear-view mirror as claimed in claim 12, wherein the housing includes a pivotal portion, and the pivotal portion is hollow sphere.

15. The rear-view mirror as claimed in claim 12, wherein the reflective mirror can freely rotate around the fixing pole.

16. The rear-view mirror as claimed in claim 13, wherein one end of the fixing pole is rotatably connected to the pivotal portion.
